(19) United States
(12) Patent Application Publication
(10) Pub. No.: US 2017/0249666 A1
(43) Pub. Date: Aug. 31, 2017

(54) METHOD, APPARATUS AND COMPUTER PROGRAM PRODUCT FOR ADVERTISING OVER A NETWORK

(71) Applicant: Cloudbanter Ltd., London (GB)

(72) Inventors: Clay Babcock, West St. Paul, MN (US); Graham Williams, London (GB)

(21) Appl. No.: 15/513,068

(22) PCT Filed: Oct. 7, 2015
(86) PCT No.: PCT/GB2015/052936

§ 371 Date: Mar. 21, 2017

(30) Foreign Application Priority Data
Oct. 19, 2014 (GB) 1418531.8
May 27, 2015 (GB) 1509034.3
Sep. 24, 2015 (GB) 1516916.2

(51) Int. Cl. G06Q 30/02; H04W 4/14; G06Q 50/00

(52) U.S. Cl. CPC G06Q 30/0267; G06Q 50/01; H04W 4/14

(57) ABSTRACT

A method for advertising over a network performed by a network entity comprising: receiving a message from a first user equipment; generating an enriched message comprising the message and an index, wherein the index corresponds to content of an advertisement in an indexed table accessible by a second user equipment; and sending the enriched message to the second user equipment.

### FIELD OF THE INVENTION

This invention relates to a method, an apparatus and a computer program product for sending information over a network.

### BACKGROUND

US 2013/0226701 A1 describes a system comprising a network entity, a first user equipment and a second user equipment. In operation, the first user equipment may send a message to the second user equipment via Short Message Service, SMS. The network entity acts as a relay. It receives the message from the first user equipment, determines an advertisement, and sends both the message and the advertisement to the second user equipment via SMS.

In a first embodiment, the network entity determines that the sum of characters contained in the message and the advertisement is less than or equal to one hundred and sixty characters, and sends the message and the advertisement in a single SMS message. In a second embodiment, the network entity determines that the sum of characters contained in the message and the advertisement is more than one hundred and sixty characters, and sends the message and the advertisement in two separate SMS messages.

The first embodiment is disadvantageous in that the size of the advertisement is limited by the size of the SMS message. Therefore, the network entity cannot always send detailed advertisements to the second user equipment. The second embodiment is disadvantageous in that it requires an increased amount of network resources to send advertisements to the second user equipment.

The invention aims at addressing the above shortcomings.

### SUMMARY

The invention relates to a method for advertising over a network performed by a network entity comprising: receiving a message from a first user equipment; generating an enriched message comprising the message and an index, wherein the index corresponds to content of an advertisement in an indexed table accessible by a second user equipment; and sending the enriched message to the second user equipment. The enriched message comprises an index corresponding to the content of an advertisement rather than the content of the advertisement. By so doing, the size of the enriched message can be minimized and thus the enriched message can be sent to the second user equipment using a reduced amount of network resource (i.e. bandwidth).

According to one feature, the method further comprises sending at least one advertisement to the second user equipment. By so doing, the second user equipment can build or update the indexed table accessible by the second user equipment.

According to another feature, the sending of at least one advertisement to the second user equipment occurs during off peak hours. By so doing, network resources can be used more efficiently over time.

According to one feature, the at least one advertisement is sent to the second user equipment via Short Message Service, SMS. SMS is a standard protocol for sending messages of up to one hundred and sixty alphanumeric characters. By so doing, the sending of the at least one advertisement to the second user equipment is simplified.

According to another feature, the at least one advertisement comprises (i) an Advert Deliver Message, ADM, including an index and content and (ii) a User Data Header, UDH, including an indicator indicating that the ADM is to be parsed and stored in the indexed table. By so doing, a message received via SMS can be identified by the mobile device as an advertisement simply by parsing the UDH. There is no need to display the message and to request a user intervention. Thus, the experience of the user of the mobile device is not degraded.

According to one feature, the ADM further comprises at least one of a global advertisement key, a style code a short code for action and space for future use.

According to another feature, the index consists of one character. By so doing, the size of the message included in the enriched message can be maximized.

According to one feature, the message is received from the first user equipment via Short Message Service, SMS, and wherein the enriched message is sent to the second user equipment via SMS.

According to another feature, the enriched message is generated only where the sum of the size of the index and the size of the message received from the first user equipment is less than or equal to a maximum size. Typically, the maximum size is one hundred and sixty characters. By so doing, the enriched message can be sent in a single message via SMS.

According to one feature, the method further comprises receiving a feedback message from the second user equipment when the second user equipment interacts with the content of the advertisement. By so doing, an operator of a network entity can detect if the second user equipment has interacted with the content of at least one advertisement. Thus, the operator of the network entity can implement a “pay-per-click” policy with an advertiser.

The invention further relates to a method for advertising over a network performed by a user equipment comprising: receiving an enriched message comprising a message and an index from a network entity, wherein the index corresponds to content of an advertisement in an indexed table accessible by the user equipment; accessing the content advertisement from the indexed table using the index; and displaying the message and the content of the advertisement.

According to one feature, the method further comprises: receiving at least one advertisement from the network entity; and building or updating the indexed table using the at least one advertisement.

According to another feature, the at least one advertisement is received during off peak hours.

According to one feature, the indexed table is stored in the user equipment. By so doing, the user equipment can have quick access to the indexed table.

According to another feature, the method further comprises: receiving a subsequent message from the network entity; accessing the content of an advertisement in the indexed table using an index included in a previously received enriched message from the network entity.

According to one feature, the method further comprises sending a feedback message from the user equipment to the network entity, when the user equipment interacts with the content of the advertisement.

The invention further relates to a network entity for advertising over a network comprising: means for receiving a message from a first user equipment; means for generating an enriched message comprising the message and an index, wherein the index corresponds to content of an advertisement in an indexed table accessible by a second user equipment; and means for sending the enriched message to the second user equipment.

According to one feature, the network entity further comprises means for sending at least one advertisement to the second user equipment.

According to another feature, the sending of at least one advertisement to the second user equipment occurs during off peak hours.

According to one feature, the at least one advertisement is sent to the second user equipment via Short Message Service, SMS

According to another feature, the at least one advertisement comprises (i) an Advert Deliver Message, ADM, including an index and content and (ii) a User Data Header, UDH, including an indicator indicating that the ADM is to be parsed and stored in the indexed table.

According to one feature, the ADM further comprises at least one of a Global Advertisement key, a style code, and a short code for action and future use.

According to another feature, each index consists of one character.

According to one feature, the message is received from the first user equipment via Short Message Service, SMS, and wherein the enriched message is sent to the second user equipment via SMS.

According to another feature, the enriched message is generated only where the sum of the size of the index and the size of the message received from the first user equipment is less than or equal to a maximum size.

According to one feature, the network entity further comprises means for receiving a feedback message from the second user equipment where the second user equipment interacts with the content of the at least one advertisement.

The invention further relates to a user equipment for advertising over a network comprising: means for receiving an enriched message comprising a message and an index from a network entity, wherein the index corresponds to content of an advertisement in an indexed table accessible by the user equipment; means for accessing the content of the advertisement from the indexed table using the index; and means for displaying the message and the content of the advertisement.

According to one feature, the user equipment further comprises: means for receiving at least one advertisement from the network entity; and means for building or updating the indexed table using the at least one advertisement.

According to another feature, the at least one advertisement is received during off peak hours.

According to one feature, the indexed table is stored in the user equipment.

According to another feature, the user further comprises: means for receiving a subsequent message from the network entity; means for accessing the content of an advertisement from the indexed table using an index included in a previously received enriched message from the network entity.

According to one feature, the user equipment further comprises means for sending a feedback from the user equipment to the network entity, where the user equipment interacts with the content of the advertisement.

The invention further relates to a non-transitory computer readable medium for equipping a network entity comprising code, which when executed by a processor, causes the processor to perform any one of the above methods.

The invention further relates to a non-transitory computer readable medium for equipping a user equipment comprising code, which when executed by a processor, causes the processor to perform any one of the above methods.

The invention further relates to a method for sending information over a network, comprising: selecting a message having a maximum size and having a first section filled with primary information; determining the size of a secondary section being the difference between the maximum size and the size of the first section; determining a portion of secondary information having a size smaller or equal to the size of the secondary section; at least partially filling the secondary section with the portion of secondary information; sending the filled message. By so doing, detailed information (which comprises a plurality of portions of information) can be sent within existing messages without increasing the traffic.

According to one feature, the method further comprises dividing the secondary information into a plurality of portions of secondary information for insertion into the secondary section of a message.

According to another feature, each portion of the plurality of portions of secondary information has a predetermined size, and portions of the secondary information are inserted into only messages for which the size of the secondary information exceeds the predetermined size. By so doing, the dividing of the information is simplified.

According to one feature, each portion of the plurality of portions of secondary information has a variable size and wherein the filled message comprises header information indicating which section is filled with primary information and which section is at least partially filled with secondary information. By so doing, the second section can be optimally filled, reducing the amount of network resources.

According to another feature, the filled message is sent via Short Message Service, SMS.

According to one feature, the method is performed by a network entity, the message is received from a first user equipment and the filled message is sent to a second user equipment.

According to another feature, the method further comprises determining by the network entity whether an amount of messages received from the first user equipment by, unit of time, is greater than a threshold. By so doing, the network entity is adapted to make a decision as to whether there is enough message traffic and therefore as to whether the information should be sent via filled messages or should be sent via another mechanism.

According to one feature, the message is received via Short Message Service, SMS.

According to another feature, the method further comprises determining by the network entity whether an amount of messages received from the first user equipment, by unit of time, is greater than a threshold.

According to another feature, wherein the message is received via Short Message Service, SMS.

According to one feature, the secondary information comprises (i) an Advert Delivery Message, ADM, including an index and content and (ii) a User Data Header, UDH, including an indicator indicating that the ADM is to be parsed and stored in an indexed table in the second user equipment, wherein the ADM further comprises at least one of a Global Advertisement Key, a style code, a short code for action and future use.

According to one feature, the method is performed by a first user equipment and wherein the filled message is sent to a first network entity, such that the first network entity can rebuild the secondary information based on the portions of secondary information and send the secondary information to a second network entity.

According to another feature, the second network entity is a web server. By so doing, information (which comprises a plurality of portions of information) can be sent to a web server without using conventional internet data.

According to one feature, the method further comprises determining by the first user equipment whether an amount of messages sent from the first user equipment to the network entity, by unit of time, is greater than a threshold. By so doing, the first user equipment is adapted to make a decision as to whether there is enough message traffic and therefore as to whether the information can be sent via filled messages or should be sent using conventional internet data.

The invention further relates to an apparatus for sending information over a network, comprising: means for selecting a message having a maximum size and having a first section filled with primary information; means for determining the size of a secondary section being the difference between the maximum size and the size of the first section; means for determining a portion of secondary information having a size smaller or equal to the size of the secondary section; means for at least partially filling the secondary section with the portion of secondary information and means for sending the filled message.

According to one feature, the apparatus further comprises means for dividing the secondary information into a plurality of portions of secondary information for insertion into the secondary section of a message.

According to another feature, each portion of the plurality of portions of secondary information has a predetermined size, and portions of secondary information are inserted into only messages for which the size of the secondary message exceeds the predetermined size.

According to one feature, each portion of the plurality of portions of secondary information has a variable size and wherein the filled message comprises header information indicating which section is filled with primary information and which portion is at least partially filled with secondary information.

According to another feature, the filled message is sent via Short Message Service, SMS.

According to one feature, the apparatus is a network entity, wherein the message is received from a first user equipment and wherein the filled message is sent to a second user equipment.

According to another feature, the apparatus further comprises means for determining whether an amount of messages received from the first user equipment by, unit of time, is greater than a threshold.

According to one feature, the message is received via Short Message Service, SMS.

According to one feature, the secondary information comprises (i) an Advert Deliver Message, ADM, including an index and content and (ii) a User Data Header, UDH, including an indicator indicating that the ADM is to be parsed and stored in an indexed table in the second user equipment, the ADM further comprises at least one of a Global Advertisement Key, a style code, a short code for action and future use.

According to one feature, the apparatus is a first user equipment (114) and wherein the filled message is sent to a first network entity (110), such that the first network entity can rebuild the secondary information based on the portions of secondary information and send the secondary information to a second network entity.

According to another feature, the second network entity is a web server.

According to one feature, the apparatus further comprises means for determining whether an amount of messages sent from the first user equipment to the network entity by unit of time is greater than a threshold.

The invention further relates to a method for receiving information over a network, comprising: receiving a message, comprising a first section filled with primary information and a second section at least partially filled with a portion of secondary information; separating the message into the primary information and the portion of secondary information; delivering the primary information for use; and storing the portion of secondary information for later rebuilding the secondary information.

According to one feature, the method further comprises receiving a plurality of messages, comprising a first section filled with primary information and a second section at least partially filled with a portion of secondary information; separating each message of the plurality of messages into primary information and the portion secondary information; delivering the primary information for use; and rebuilding the secondary information based on the portions of secondary information. In one embodiment, an SMS application is running. Where the SMS application is used, a display comprises a primary information window and a secondary information window. The delivering comprises displaying the primary information in the primary information window to be read by a user. In addition, the rebuilt secondary information can be displayed in a secondary information window. In a second embodiment, an SMS application and a social network application can both be running. Where the SMS application is used, a display comprises a primary information window. The delivering comprises displaying the primary information in the primary information window to be read by a user. In addition, where the social network application is used, the display comprises a secondary information window in which the rebuilt secondary information can be displayed.

According to another feature, each portion of secondary information has a predetermined size and portions of the secondary information are inserted into only messages for which the size of the secondary information exceeds the predetermined size.

According to one feature, each portion of secondary information has a variable size and wherein the message comprises header information indicating which section is filled with primary information and which section is at least partially filled with secondary information.

According to another feature, the filled message is received via Short Message Service, SMS.

According to one feature, the method is performed by a user equipment, wherein the message is received from a network entity.

According to another feature, the method further comprises displaying the primary information of the message.

According to another feature, the secondary information comprises; (i) an Advert Delivery Message, ADM, including an index and content and (ii) a User Data Header, UDH, including an indicator indicating that the ADM is to be parsed and stored in an indexed table in the second user equipment, wherein the ADM further comprises at least one of a Global Advertisement Key, a style code, a short code for action and future use.

According to another feature, the method is performed by a network entity, wherein the message is received from a first user equipment.

According to one feature, the method further comprises sending the secondary information to a second network entity.

According to another feature, the second network entity is a web server.

The invention further relates to an apparatus for receiving information over a network, comprising: means for receiving a message, comprising a first section filled with primary information and a second section at least partially filled with a portion of secondary information; means for separating the message into the primary information and the portions of secondary information; means for delivering the primary information for use; and means for storing the portion of secondary information for later rebuilding the secondary information.

According to one feature, the apparatus further comprises means for receiving a plurality of messages, comprising a first portion occupied by primary information and a second portion occupied by secondary information; means for separating each message of the plurality of messages into the primary information and the portions of secondary information; and means for rebuilding secondary information based on the portions of secondary information.

According to another feature, each portion of secondary information has a predetermined size and portions of the secondary information are inserted into only messages for which the size of the secondary information exceeds the predetermined size.

According to one feature, each portion of secondary information has a variable size and wherein the message comprises header information indicating which section is filled with primary information and which section is at least partially filled with secondary information.

According to another feature, the filled message is received via Short Message Service, SMS.

According to one feature, the method is performed by a user equipment, wherein the message is received from a network entity.

According to another feature, the apparatus further comprises means for displaying the primary information of the message.

According to another feature, the secondary information comprises; (i) an Advert Delivery Message, ADM, including an index and content and (ii) a User Data Header, UDH, including an indicator indicating that the ADM is to be parsed and stored in an indexed table in the second user equipment, wherein the ADM further comprises at least one of a Global Advertisement Key, a style code, a short code for action and future use.

According to another feature, the method is performed by a network entity, wherein the message is received from a first user equipment.

According to one feature, the apparatus further comprises means for sending the secondary information to a second network entity.

According to another feature, the second network entity is a web server.

The invention finally relates to a non-transitory computer readable medium for equipping an apparatus comprising code, which when executed by a processor, causes the processor to perform any of the above methods.

Other features and advantages of the invention will become apparent after review of the entire application, including the following sections: brief description of the drawings, detailed description and claims.

### BRIEF DESCRIPTION OF THE DRAWINGS

The accompanying drawings illustrate exemplary aspects of the invention, and, together with the general description given above and the detailed description given below, serve to explain features of the invention.

FIG. 1 illustrates a system for advertising over a network.

FIG. 2 illustrates an indexed table stored in a UE equipped with an improved SMS client in the system of FIG. 1.

FIG. 3 illustrates a flow chart of a method for building/updating/storing the indexed table of FIG. 2.

FIG. 4 illustrates a flow chart of a method for sending an SMS message, from a first UE equipped with an improved SMS client to second UE equipped with an improved SMS client, in the system of FIG. 1.

FIG. 5 illustrates a flow chart of a first method for sending a SMS message, from a first UE not equipped with an improved SMS client to second UE equipped with an improved SMS client, in the system of FIG. 1.

FIG. 6 illustrates a flow chart of a second method for sending a SMS message, from a first UE not equipped with an improved SMS client to second UE equipped with an improved SMS client, in the system of FIG. 1.

FIG. 7 illustrates a UE equipped with an improved SMS client displaying a SMS message and content of an ADM.

FIG. 8 illustrates a flow chart of a method for sending a SMS advertisement, from a network entity to a UE that is equipped with an improved SMS client, in the system of FIG. 1.

FIG. 9 illustrates a flow chart of a method for sending a social media post from a UE that is equipped with an improved SMS client to a web server, in the system of FIG. 1.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

FIG. 1 shows a system 100 including an internet network 102 and a mobile network 104. The system 100 comprises network entities 106, 108, 110 and user equipments (UEs) 112, 114 and 116. It should be understood that although network entities 106, 108 and 110 are illustrated as separate elements, they may be regrouped into a single element. In addition, it should be understood that although UEs 112, 114 and 116 are illustrated as being equipped with separate components (for the clarity and conciseness), they may be all equipped with the same components.

Network entity 106 is typically housed at an advertising agency. Network entity 106 comprises a memory 118 and an advertisement interface 120. The memory is configured to store a set of Advertisement Delivery Messages (ADMs). The advertisement interface 120 is configured to send the set of ADMs to the network entity 108. Each ADM consists of a plurality of characters arranged to meet a format requirement. Each ADM comprises at least content and an index. The index can be used to build or update an indexed table in UE 116 and to locate the ADM within the indexed table. Each ADM may further comprise a global advertisement key that uniquely identifies the ADM in the system 100, a style code that identifies style features (e.g. font, size of characters) to be applied to the content, a short code for action (i.e. a link to a webpage) and/or space for future use.

In one embodiment, the ADM is written in a language (e.g. English, Spanish, French, etc.) requiring a single-byte character set (e.g. ASCII, ISO-8859 in any of its parts, or UTF-8). In this embodiment, the index typically consists of one character, the content typically consists of one hundred and twenty characters, the global advertisement key typically consists of five characters, the style code typically consists of four characters, and the short code for action typically consists of eight characters. In another embodiment, the ADM is written in a language requiring a double-byte character set (e.g. Chinese, Japanese, Hindi, etc.). In this embodiment, the index typically consists of one character, the content typically consists of sixty characters, the global advertisement key typically consists of three characters, the style code typically consists of one character, the short code for action typically consists of eight characters.

Network entity 108 is typically housed at the Applicant. It comprises an advertisement interface 122, a memory 124, an advertisement manager 126, a personalisation manager 128, a program manager 130 and a bill manager 132. It should be understood that although bill manager and program manager are illustrated as separate elements, they may be regrouped into a single element.

Advertisement interface 122 is configured to receive the set of ADMs from network entity 106 and to store them in memory 124. Advertisement interface 122 is further configured to send a subset of ADMs to network entity 110. Advertisement manager 126 is configured to check the set of ADMs to ensure that each ADM meets the format requirement described above.

Personalisation manager 128 is configured to select a subset of ADMs from the set of ADMs to be sent to UE 116. For example, the subset of ADMs may be selected based on profile information provided by UE 116 (or by the user of UE 116), such as age or gender. The subset of ADMs may be selected based on personal interest information provided by UE 116. For example, UE 116 indicates an interest towards advertisement for motorcycles.

Program manager 130 is configured to control how many times each content of an ADM of the subset of ADMs is to be displayed by UE 116. Bill Manager 132 is configured to control how many times each content of an ADM of the subset of ADMs is interacted with by UE 116. By so doing, the program manager 130 and the bill manager 132 can implement an advertising campaign set out by the network entity 106.

Network entity 110 is typically housed at a mobile operator (but most of the software executed thereon is owned by the Applicant). It comprises an advertisement interface 134, a memory 136, a social media interface 138, an advertisement blender 140 and a short message service centre (SMSC) 142. Advertisement interface 134 receives the subset of ADMs from network entity 108 and stores them in memory 136. Social media interface 138 allows interaction with social media organisations such as Facebook and Twitter.

Advertisement blender 140 is configured to generate a subset of SMS advertisements by adding a User Data Header (UDH) to each ADM of the subset of ADMs. Each SMS advertisement contains one hundred and sixty characters. The UDH enables UE 116 to identify a SMS advertisement. Advertisement blender 140 is further configured to generate enriched messages by adding an index of an ADM of the subset of ADMS to SMS messages. SMSC 142 is configured to send the SMS advertisements to a user equipment. The SMSC 142 may advantageously send the SMS advertisement during off peak hours configured by the operator (e.g. Between 02:00 and 04:00 hours local time).

SMSC 142 is configured to send the subset of SMS advertisement to UE 116. In one embodiment, the SMS advertisement is sent in a single SMS message. In a second embodiment, the SMS advertisement is sent in a plurality of filled SMS. SMSC 142 is further configured to send enriched SMS messages generated by the advertisement blender 140 to UE 116.

UE 112 comprises a standard SMS client 144 and a network transmitter/receiver 146. The standard SMS client 144 is configured to generate a SMS message of up to one hundred and sixty characters. The network transmitter/receiver 146 is configured to send a SMS message to network entity 110. UE 114 comprises an improved SMS client 148, a network transmitter/receiver 150 and a social media interface 160.

The improved SMS client 148 is configured to generate a SMS message of up to one hundred and fifty nine characters. The network transmitter/receiver 150 is configured to send a SMS message to network entity 110.

The improved SMS client can take the form of a program that can be downloaded by some UE equipped with a standard SMS client predetermined by the Applicant. The improved SMS client is then determined as a default SMS client by the operating system of the UE.

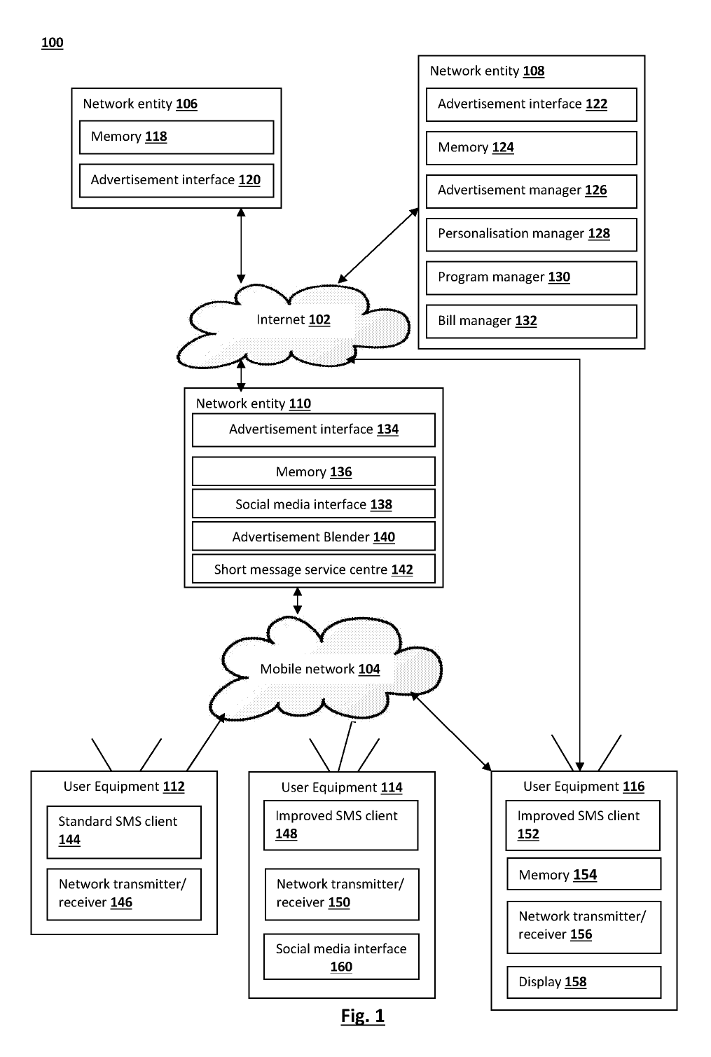

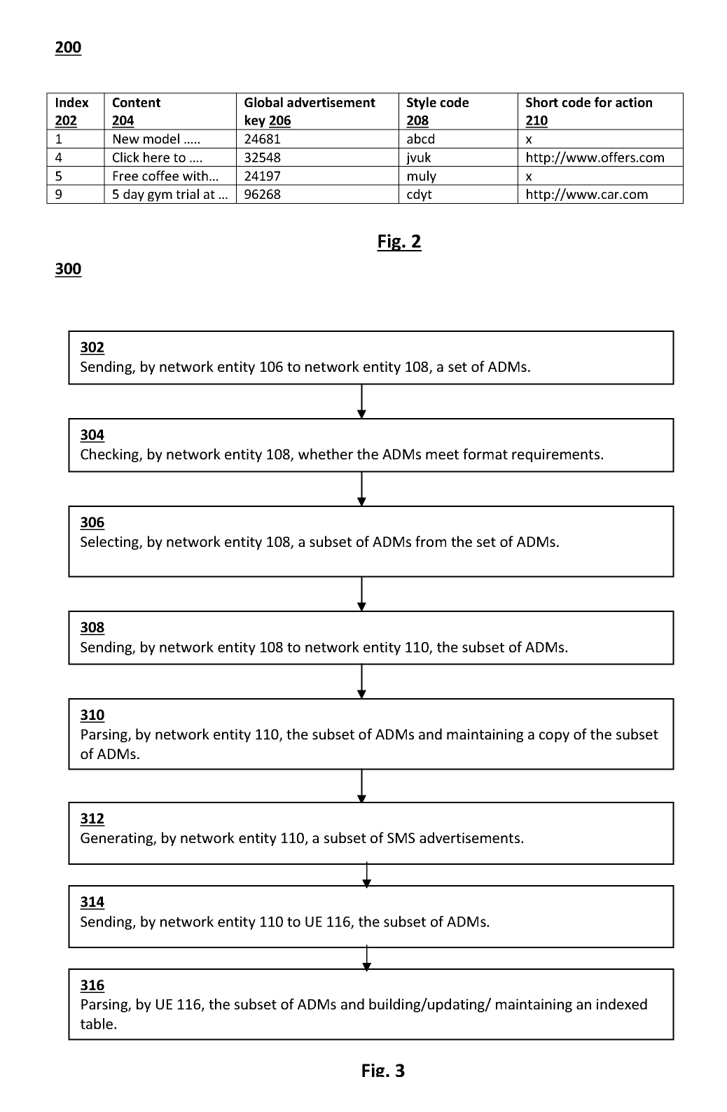

UE 116 comprises an improved SMS client 152, a memory 154, a network transmitter/receiver 156 and a display 158. The improved SMS client 152 is configured to receive SMS advertisements from network entity 110, to retrieve ADMs from the SMS advertisements and to build/update/store an indexed table in memory 154 based on the ADMS. An example of an indexed table is illustrated on FIG. 2. The improved SMS client 152 is further configured to receive an enriched SMS message from network entity 110 via the a network transmitter/receiver 156, to retrieve the SMS message from the enriched SMS message, to retrieve an index from the enriched SMS message, to locate an ADM stored in the indexed table and to retrieve the ADM (at least the style code and the content).

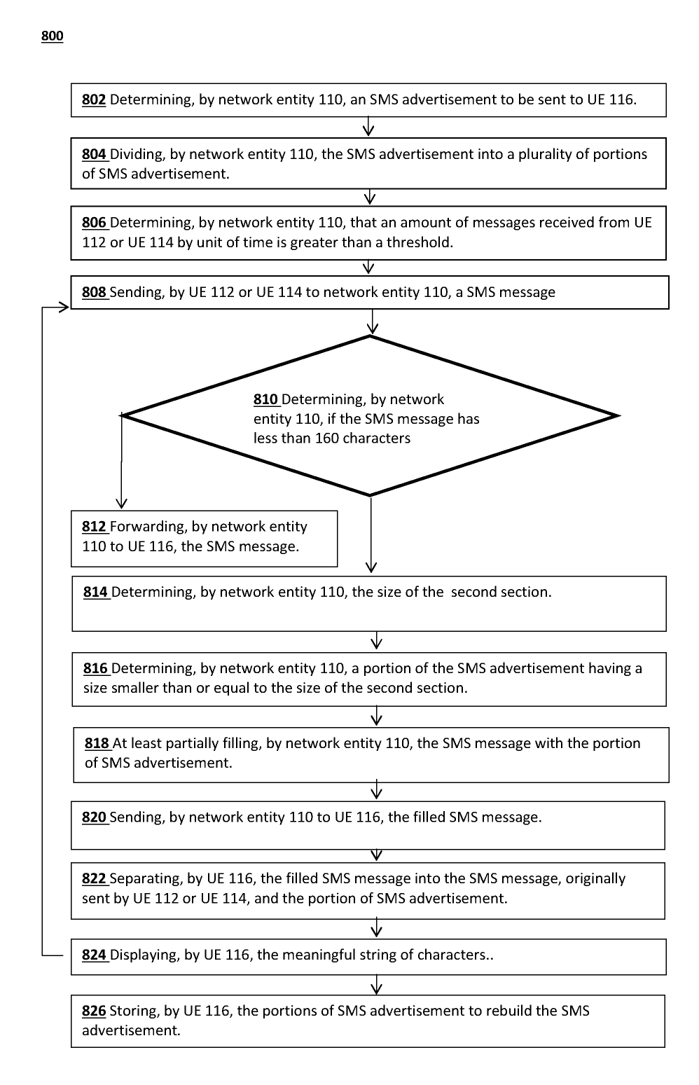

The display 158 is configured to display the SMS message and the content of the ADM (see FIG. 7). The content of the ADM is displayed in accordance to the style code of the ADM. Finally, the improved SMS client 152 is configured to detect an interaction with the content of the advertisement (e.g. saving of the content in memory or clicking on the action code) and to send a feedback message to the network entity 108. In one embodiment, the feedback is sent to network entity 108 via the internet network 102 (e.g. email). In another embodiment, the feedback is sent to network entity 108 via the mobile network 104 and the internet network 102 (e.g. SMS message).

FIG. 2 shows an example of an indexed table 200 built/updated/maintained in UE with an improved SMS client. The indexed table 200 references four ADMs. For each ADM, the indexed table 200 includes an index 202, content 204, an optional global advertisement key 206, an optional style code 208 and an optional short code for action 210.

FIG. 3 shows a method 300 for building/updating/maintaining the indexed table 200 in UE 116. At step 302, the advertisement interface 120 of the network entity 106 sends the set of ADMs stored in memory 118 to the advertisement interface 122 of the network entity 108. At step 304, network entity 108 receives the set of ADMs from network entity 106. The advertisement manager 126 checks whether each ADM of the set of ADMs meets the format requirement and stores the set of ADMs in memory 124. At step 306, personalisation manager 128 selects a subset of ADMs from the set of ADMs based on, for example, the profile information provided by/for the UE 116, such as age or gender and/or the personal interest information provided by/for UE 116. At step 308, the advertisement interface 122 of network entity 108 sends the subset of ADMs to the advertisement interface 134 of network entity 110.

At step 310, the advertisement interface 134 of network entity 110 receives and parses the subset of ADMs. The advertisement interface 134 maintains a copy of the subset of ADMs in memory 136. At step 312, the advertisement blender 140 generates a subset of SMS advertisements by adding the UDH to each ADM of the subset of ADMs. At step 314, the SMSC 142 sends the subset of SMS advertisements to the network transmitter/receiver 156 of UE 116 (as described above). At step 316, the improved SMS client 152 parses incoming SMS messages for the UDH header and, if found, identifies the incoming SMS messages as the subset of SMS advertisements. The improved SMS client 152 then retrieves the subset of ADMs from within the subset of SMS advertisements and builds/updates/maintains the indexed table of ADMs.

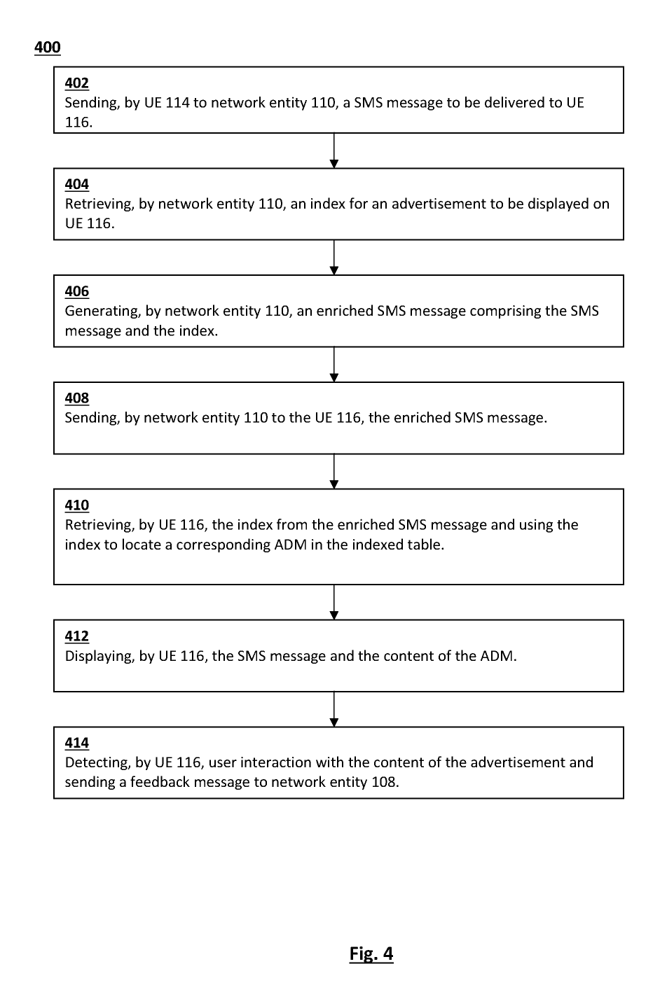

FIG. 4 shows a method 400 for displaying a SMS message, sent by UE 114, and the content of an ADM at UE 116. At step 402, the improved SMS client 148 of UE 114 generates the SMS message and the network transmitter/receiver 150 sends the SMS message to the network SMSC 142 of network entity 110. As a result of generating the SMS message using the improved SMS client 148, the SMS message contains a maximum of one hundred and fifty nine characters. At step 404, the SMSC 142 of network entity 110 receives the SMS message from UE 114. The advertisement blender 140 retrieves an index of an ADM from the subset of ADMs stored in memory 136. At step 406, the advertisement blender 140 generates an enriched SMS message comprising the SMS message and the index. At step 408, the SMSC 142 sends the enriched SMS message to the improved SMS client 152 of UE 116 via the network transmitter/receiver 156.

At step 410, UE 116 receives the enriched SMS message. The improved SMS client 152 retrieves the index from the enriched SMS message. The index is used to locate an ADM stored in the indexed table 200 and to retrieve at least the style code and content of the ADM corresponding to the index. At step 412, the display 158 displays the SMS message and the content of the ADM in accordance with the style code (see FIG. 7). At step 414, the improved SMS client 152 detects an interaction with the content of the advertisement (e.g. a click by a user) and sends feedback to the network entity 108 via mobile network 104 and/or internet 102.

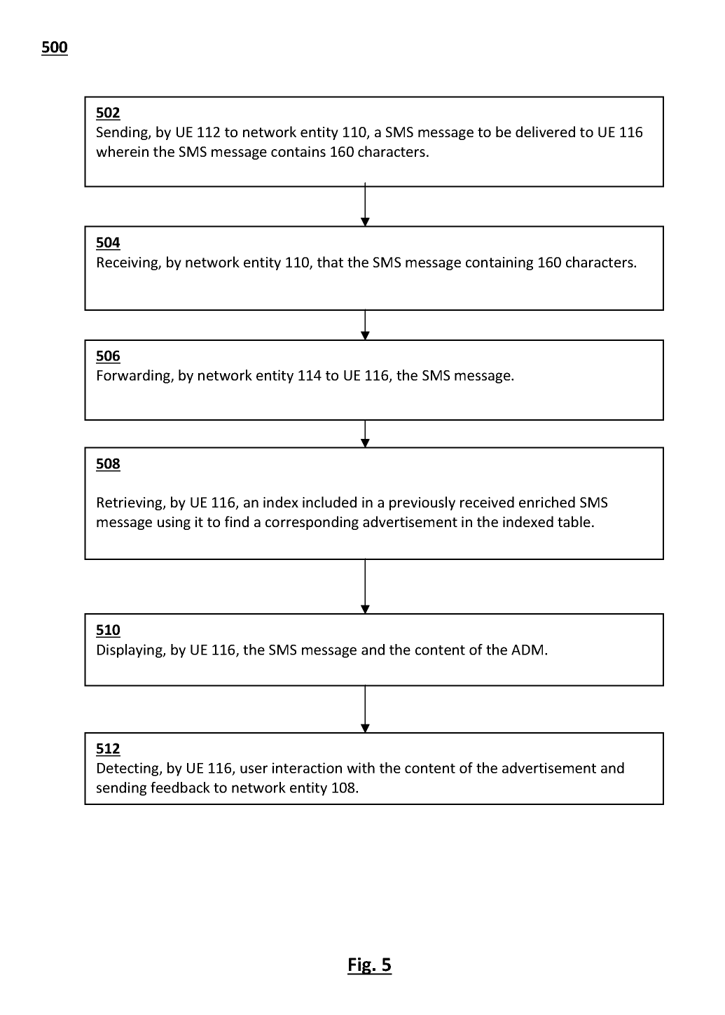

FIG. 5 shows a method 500 for displaying a SMS message sent by UE 112 and the content of an ADM at UE 116. At step 502, the standard SMS client 144 of UE 112 sends the SMS message SMSC 142 of network entity 110. As a result of generating the SMS message using the standard SMS client 144, the SMS message contains a maximum of one hundred and sixty characters. In this example, the SMS message contains one hundred and sixty characters. At step 504, the SMSC 142 of network entity 110 receives the SMS message from UE 112. At step 506, because the SMS message contains one hundred and sixty characters, the advertisement blender 140 cannot generate an enriched SMS message comprising the SMS message and an index. Instead, the SMSC 142 forwards the SMS message to the improved SMS client 152 of UE 116 via the network transmitter/receiver 156.

At step 508, UE 116 receives the SMS message. The improved SMS client 152 retrieves the index included in the previously received enriched SMS message (see FIG. 4). The index is used to locate an ADM stored in the indexed table 200 and retrieve at least the style code and content of the ADM corresponding to the index. At step 510, the display 158 displays the SMS message and the content of the ADM in accordance with the style code (see FIG. 7). At step 512, the improved SMS client 152 detects an interaction with the content of the advertisement and sends feedback to the network entity 108 via mobile network 104 and/or internet 102.

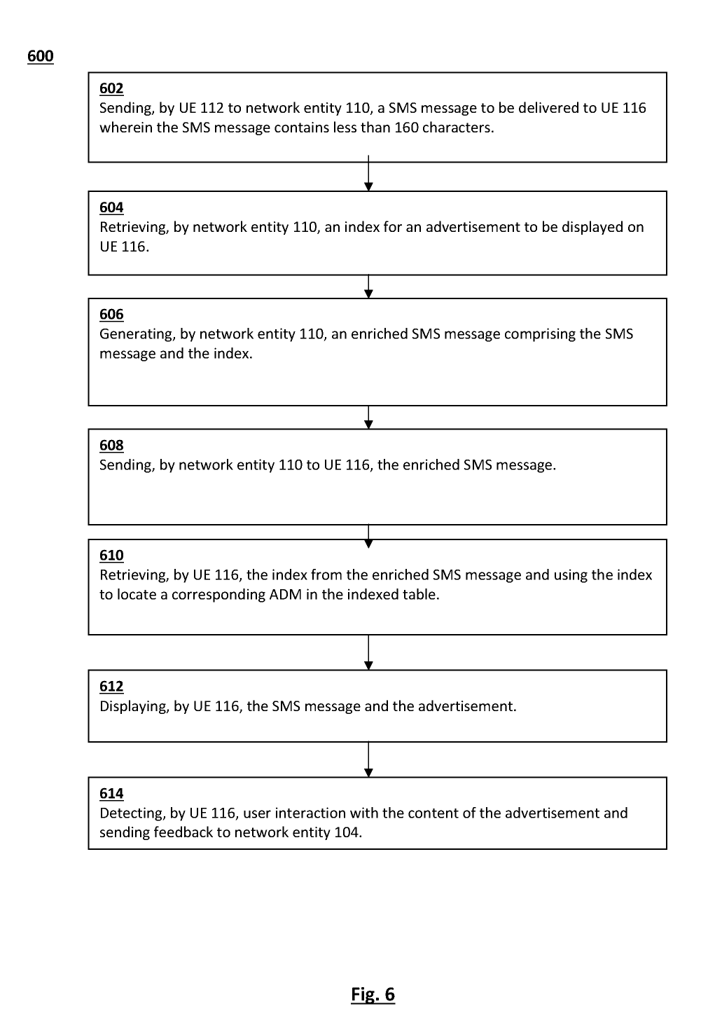

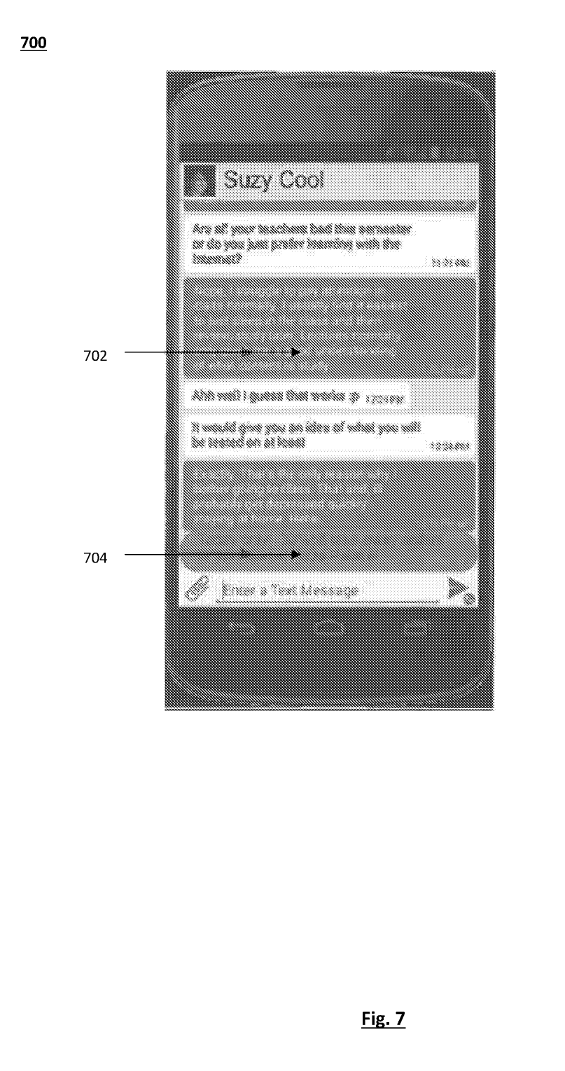

FIG. 6 shows another method 600 for displaying a SMS message sent by UE 112 and the content of an ADM at UE 116. In step 602, the standard SMS client 144 of UE 112 sends the SMS message SMSC 142 of network entity 110. As a result of generating the SMS message using the standard SMS client 144, the SMS message contains a maximum of one hundred and sixty characters. In this example, the SMS message contains less than one hundred and sixty characters. At step 604, the SMSC 142 of network entity 110 receives the SMS message from UE 112. The advertisement blender 140 retrieves an index of an ADM from the subset of ADMs stored in memory 136. At step 606, the advertisement blender 140 generates an enriched SMS message comprising the SMS message and the index. At step 608, the SMSC 142 sends the enriched SMS message to the improved SMS client 152 of UE 116 via the network transmitter/receiver 156.

At step 610, UE 116 receives the enriched SMS message. The improved SMS client 152 retrieves the index from the enriched SMS message. The index is used to locate an ADM stored in the indexed table 200 and retrieve at least the style code and content of the ADM corresponding to the index. At step 612, the display 158 displays the SMS message and the content of the ADM in accordance with the style code (see FIG. 7). At step 614, the improved SMS client 152 detects an interaction with the content of the advertisement and sends feedback to the network entity 108 via mobile network 104 and/or internet 102.

FIG. 7 shows the display 158 of UE 116displaying a SMS message and content of an ADM in accordance with a style code on according to one embodiment. The SMS message is displayed in a first window 702 and the content of the ADM is displayed in a second window. For example, the second window 704 is at the bottom of the first window 702 (or some position and shape defined by the style code). By so doing, the content of the ADM is displayed in an unobtrusive manner.

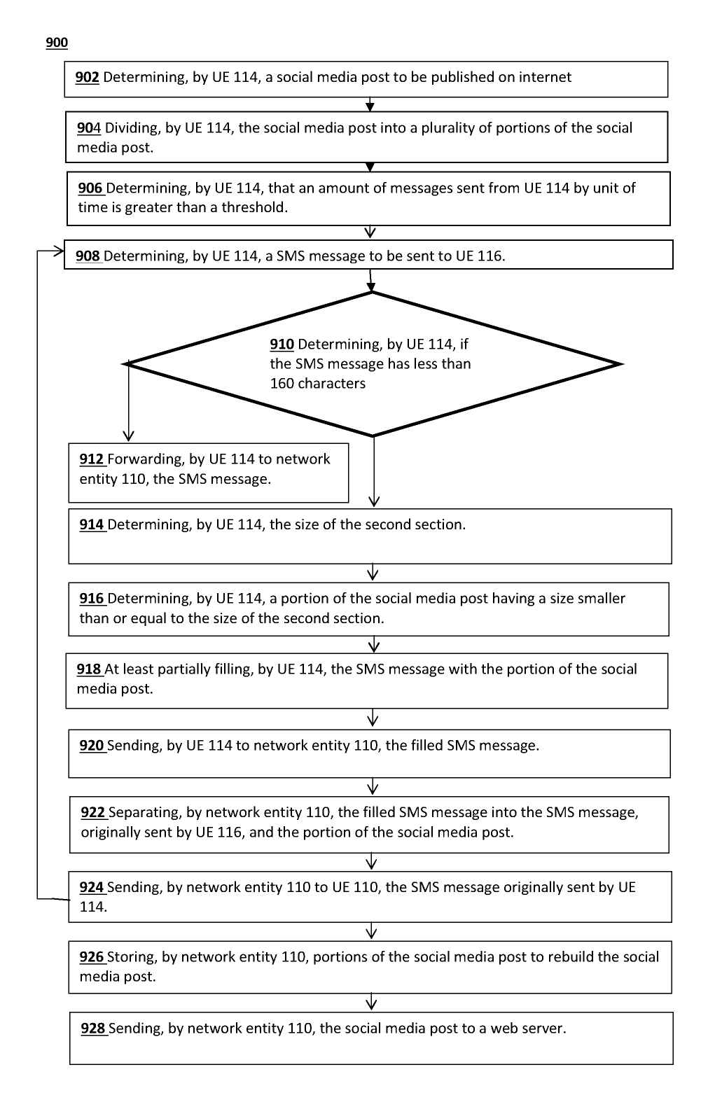

FIG. 8 shows a method 800 for sending a SMS advertisement from network entity 110 to UE 116. A SMS message has a maximum size of one hundred and sixty characters and comprises a first section filled with a meaningful string of characters (i.e. a text typed by a user), and a second section that is the difference between the maximum size of the SMS message and the size of the first section. The second section consists of unused characters and is therefore available space that can be filled at least partially with a portion of the SMS advertisement.

At step 802, the advertisement blender 134 determines a SMS advertisement to be sent to UE 116. At step 804, the advertisement blender 134 divides the SMS advertisement into a plurality of portions of the SMS advertisement. In an embodiment, the portions of the SMS advertisement have a predetermined size. In another embodiment, the portions of the SMS advertisement have a variable size. The SMS message advantageously comprises header information that indicates which section of the SMS message is the first section and which section of the SMS message is the second section. At step 806 the SMSC 142 determines that an amount of SMS messages received from UE 112 and UE 114, by unit of time, is greater than a threshold.

At step 808, UE 112 or UE 114 sends a SMS message to SMSC 142 to be delivered to UE 116. At step 810, the advertisement blender determines if the SMS message, to be delivered to UE 116, has less than one hundred and sixty characters.

If the SMS message does not have less than one hundred and sixty characters (e.g. the size of the second section is zero) then it is forwarded to the network transmitter/receiver 156 of UE 116, step 812.

By contrast, if the SMS message does have less than one hundred and sixty characters then the advertisement blender 140 determines the size of the second section in the SMS message, step 814. At step 816, the advertisement blender 140 determines a portion of the SMS advertisement having a size smaller or equal to the size of the second section in the SMS message. At step 818, the advertisement blender 140 fills the second section of the SMS message with the portion of the SMS advertisement. At step 80, the SMSC 142 sends the filled SMS message to the network transmitter/receiver 156 of UE 116.

At step 822, the improved SMS client 152 of UE 116 separates the filled SMS message into the meaningful string of characters, and the portion of the SMS advertisement. The portion of the SMS advertisement is then stored in memory 154. At step 824, the display 158 displays a notification indicating the reception of a SMS message and upon opening of this notification the display 158 displays the meaningful string of characters Step 808 through to step 824 are repeated so that the plurality of portions of the SMS advertisement can be stored in memory 154. At step 826, the improved SMS client 152 aggregates the plurality of portions of the SMS advertisement to rebuild the SMS advertisement originally determined to be sent to UE 116. The improved SMS client 152 retrieves the SMS advertisement and builds/updates/maintains the indexed table 200.

FIG. 9 shows a method 900 for sending a social media post by UE 114 to a web server. A SMS message has a maximum size of one hundred and sixty characters and comprises a first section filled with meaningful string of characters (i.e. a text typed by a user) and a second section that is the difference between the maximum size of the SMS message and the size of the first section. The second section consists of unused characters and is therefore available space that can be filled at least partially with a portion of the social media post.

At step 902, the improved SMS client 148 of UE 114 determines a social media post to be published on the internet. At step 904, the social media interface 160 divides up the social media post into a plurality of portions of social media post. In an embodiment, the portions of the social media post have a predetermined size. In another embodiment, the portions of the social media post have a variable size. The SMS message advantageously comprises header information that indicates which section of the SMS message the first section and which section of the SMS message is the second section. At step 906, the improved SMS client 148 determines that an amount of messages sent from UE 114, by unit of time, is greater than a threshold. At step 908, the improved SMS client 148 determines a SMS message to be sent to UE 116. At step 910, the improved SMS client 148 determines if the SMS message, to be delivered to UE 116, has less than one hundred and sixty characters.

If the SMS message does not have less than one hundred and sixty characters (e.g. the size of the second section is zero) then it is forwarded to the SMSC 142 of network entity 110, at step 912.

By contrast, if the SMS message does have less than one hundred and sixty characters then the improved SMS client 148 determines the size of the second section in the SMS message, at step 914. At step 916, the improved SMS client 148 determines a portion of the social media post having a size smaller than or equal to the size of the second section in the SMS message. At step 918, the improved SMS client 148 fills the second section with the portion of the social media post. At step 920, the network transmitter/receiver 150 sends the filled SMS message to the SMSC 142 of network entity 110.

At step 922, the social media interface 138 separates the filled SMS message into the meaningful string of characters and the portion of the social media post. At step 924, the SMSC 142 sends the SMS message (which has been deprived of the portion of the social media post) to the network transmitter/receiver 156 of UE 116. The display 158 of UE 116 displays a notification indicating the reception of a SMS message and upon opening this notification the display 158 displays the meaningful string of characters Step 908 through to step 924 are repeated so that the plurality of portions of the social media post can be stored in memory 136. At step 926, the social media interface 138 aggregates the portions of the social media post to rebuild the social media post originally determined to be published on the internet. At step 928, the social media interface 138, sends the rebuilt social media post to a web server.

1. A method for advertising over a network performed by a network entity (110) comprising:
receiving a message from a first user equipment (112, 114);
generating an enriched message comprising the message and an index, wherein the index corresponds to content of an advertisement in an indexed table (200) accessible by a second user equipment (116); and
sending the enriched message to the second user equipment (116).

2. A method according to claim 1, further comprising sending at least one advertisement to the second user equipment (116).

3. A method according to claim 2, wherein the sending of at least one advertisement to the second user equipment (116) occurs during off-peak hours.

4. A method according to any of claims 2 to 3, wherein the at least one advertisement is sent to the second user equipment (116) via Short Message Service, SMS.

5. A method according to any one of claims 2 to 4, wherein the at least one advertisement comprises (i) an Advert Deliver Message, ADM, including an index and content and (ii) a User Data Header, UDH, including an indicator indicating that the ADM is to be parsed and stored in the indexed table (200).

6. A method according to claim 5, wherein the ADM further comprises at least one of a Global Advertisement Key, a style code, a short code for action and future use.

7. A method according to any one of claims 1 to 6, wherein the index consists of one character.

8. A method according to any one of claims 1 to 7, wherein the message is received from the first user equipment (112, 114) via Short Message Service, SMS, and wherein the enriched message is sent to the second user equipment (116) via SMS.

9. A method according to claim 8, wherein the enriched message is generated only where the sum of the size of the index and the size of the message received from the first user equipment (112, 114) is less than or equal to a maximum size.

10. A method according to any one of claims 1 to 9, further comprising receiving a feedback message from the second user equipment (116) when the second user equipment (116) interacts with the content of the advertisement.

11. A method for advertising over a network performed by a user equipment (116) comprising:
receiving an enriched message comprising a message and an index from a network entity (110), wherein the index corresponds to content of an advertisement in an indexed table (200) accessible by the user equipment;
accessing the content advertisement from the indexed table (200) using the index; and
displaying the message and the content of the advertisement.

12. A method according to claim 11, further comprising:
receiving at least one advertisement from the network entity (110); and
building or updating the indexed table (200) using the at least one advertisement.

13. A method according to claim 12, wherein the at least one advertisement is received during off peak hours.

14. A method according to any one of claims 11 to 13, wherein the indexed table (200) is stored in the user equipment (116).

15. A method according to any one of claims 11 to 14, further comprising:
receiving a subsequent message from the network entity (110);
accessing the content of an advertisement in the indexed table (200) using an index included in a previously received enriched message from the network entity (110).

16. A method according to any one of claims 11 to 15, further comprising sending a feedback message from the user equipment (116) to the network entity (110), when the user equipment (116) interacts with the content of the advertisement.

17. A network entity (110) for advertising over a network comprising:
means for receiving a message from a first user equipment (112, 114);
means for generating an enriched message comprising the message and an index, wherein the index corresponds to content of an advertisement in an indexed table (200) accessible by a second user equipment (116); and
means for sending the enriched message to the second user equipment (116).

18. A network entity (110) according to claim 17, further comprising means for sending at least one advertisement to the second user equipment (116).

19. A network entity (110) according to claim 18, wherein the sending of at least one advertisement to the second user equipment (116) occurs during off peak hours.

20. A network entity (110) according to any one of claims 18 to 19, wherein the at least one advertisement is sent to the second user equipment (116) via Short Message Service, SMS

21. A network entity (110) according to any one of claims 18 to 20, wherein the at least one advertisement comprises (i) an Advert Deliver Message, ADM, including an index and content and (ii) a User Data Header, UDH, including an indicator indicating that the ADM is to be parsed and stored in the indexed table (200).

22. A network entity (110) according to claim 21, wherein the ADM further comprises at least one of a Global Advertisement Key, a style code, a short code for action and future use.

23. A network entity (110) according to any one of claims 17 to 22, wherein each index consists of one character.

24. A network entity (110) according to any one of claims 17 to 23, wherein the message is received from the first user equipment (112, 114) via Short Message Service, SMS, and wherein the enriched message is sent to the second user equipment (116) via SMS.

25. A network entity (110) according to any one of claims 17 to 24, wherein the enriched message is generated only where the sum of the size of the index and the size of the message received from the first user equipment (112, 114) is less than or equal to a maximum size.

26. A network entity (110) according to any one of claims 17 to 25, further comprising means for receiving a feedback message from the second user equipment (116) where the second user equipment (116) interacts with a content of the at least one advertisement.

27. A user equipment (116) for advertising over a network comprising:
means for receiving an enriched message comprising a message and an index from a network entity (110), wherein the index corresponds to content of an advertisement in an indexed table (200) accessible by the user equipment (116);
means for accessing the content of the advertisement from the indexed table (200) using the index; and
means for displaying the message and the content of the advertisement.

28. A user equipment (116) according to claim 27, further comprising:
means for receiving at least one advertisement from the network entity (110); and
means for building or updating (200) the indexed table using the at least one advertisement.

29. A user equipment (116) according to claim 27, wherein the at least one advertisement is received during off peak hours.

30. A user equipment (116) according to any one of claims 27 to 29, wherein the indexed table (200) is stored in the user equipment (116).

31. A user equipment (116) according to any one of claims 27 to 30, further comprising:
means for receiving a subsequent message from the network entity (110);
means for accessing the content of an advertisement from the indexed table (200) using an index included in a previously received enriched message from the network entity (110).

32. A user equipment (116) according to any one of claims 27 to 31, further comprising means for sending a feedback message, where the user equipment (116) interacts with the content of the advertisement.

33. A non-transitory computer readable medium (136) for equipping a network entity comprising code, which when executed by a processor, causes the processor to perform a method according to any one of claims 1 to 10.

34. A non-transitory computer readable medium (154) for equipping a user equipment comprising code, which when executed by a processor, causes the processor to perform a method according to any one of claims 11 to 16.

35. A method for sending information over a network, comprising:
selecting a message having a maximum size and having a first section filled with primary information (808, 908);
determining the size of a secondary section being the difference between the maximum size and the size of the first section (814, 914);
determining a portion of secondary information having a size smaller or equal to the size of the secondary section (816, 916);
at least partially filling the secondary section with the portion of secondary information (818, 918); and
sending the filled message (820, 920).

36. A method according to claim 35, further comprising dividing the secondary information into a plurality of portions of secondary information for insertion into the secondary section of a message (804, 904).

37. The method of claim 36, wherein each portion of the plurality of portions of secondary information has a predetermined size, and portions of the secondary information are inserted into only messages for which the size of the secondary information exceeds the predetermined size.

38. The method of claim 36, wherein each portion of the plurality of portions of secondary information has a variable size and wherein the filled message comprises header information indicating which section is filled with primary information and which section is at least partially filled with secondary information.

39. A method according to any one of claims 35 to 38, wherein the filled message is sent via Short Message Service, SMS.

40. A method according to any one of claims 35 to 39, wherein the method is performed by a network entity (110), wherein the message is received from a first user equipment (112, 114), and wherein the filled message is sent to a second user equipment (116).

41. A method according to claim 38, further comprising determining by the network entity (110) whether an amount of messages received from the first user equipment, by unit of time, is greater than a threshold (806).

42. A method according to any one of claims 40 to 41, wherein the message is received via Short Message Service, SMS.

43. A method according to any one of claims 40 to 42, wherein the secondary information comprises (i) an Advert Delivery Message, ADM, including an index and content and (ii) a User Data Header, UDH, including an indicator indicating that the ADM is to be parsed and stored in an indexed table in the second user equipment, wherein the ADM further comprises at least one of a Global Advertisement Key, a style code, a short code for action and future use.

44. A method according to any one of claims 35 to 39, wherein the method is performed by a first user equipment (114) and wherein the filled message is sent to a first network entity (110), such that the first network entity (110) can rebuild the secondary information based on the portions of secondary information and send the secondary information to a second network entity.

45. A method according to claim 44, wherein the second network entity is a web server.

46. A method according to any one of claims 44 to 45, further comprising determining by the first user equipment (114) whether an amount of messages sent from the first user equipment (114) to the network entity (110), by unit of time, is greater than a threshold (906).

47. An apparatus for sending information over a network, comprising:
means for selecting a message having a maximum size and having a first section filled with primary information (808, 908);
means for determining the size of a secondary section being the difference between the maximum size and the size of the first section (814, 914);
means for determining a portion of secondary information having a size smaller or equal to the size of the secondary section (816, 916);
means for at least partially filling the secondary section with the portion of secondary information (818, 918); and
means for sending the filled message (820, 920).

48. An apparatus according to claim 47, further comprising means for dividing the secondary information into a plurality of portions of secondary information for insertion into the secondary section of a message (804, 904).

49. An apparatus according to claim 48, wherein each portion of the plurality of portions of secondary information has a predetermined size, and portions of secondary information are inserted into only messages for which the size of the secondary message exceeds the predetermined size.

50. An apparatus according to claim 48, wherein each portion of the plurality of portions of secondary information has a variable size and wherein the filled message comprises header information indicating which section is filled with primary information and which portion is at least partially filled with secondary information.

51. An apparatus according to any one of claims 47 to 50, wherein the filled message is sent via Short Message Service, SMS.

52. The apparatus according to any one of claims 47 to 51, wherein the apparatus is a network entity (110), wherein the message is received from a first user equipment (112, 114), and wherein the filled message is sent to a second user equipment (116).

53. An apparatus according to claim 52, further comprising means for determining whether an amount of messages received from the first user equipment by, unit of time, is greater than a threshold (806).

54. An apparatus according to any one of claims 52 to 53, wherein the message is received via Short Message Service, SMS.

55. An apparatus according to claims 52 to 54, wherein the secondary information comprises (i) an Advert Deliver Message, ADM, including an index and content and (ii) a User Data Header, UDH, including an indicator indicating that the ADM is to be parsed and stored in an indexed table in the second user equipment, the ADM further comprises at least one of a Global Advertisement Key, a style code, a short code for action and future use.

56. The apparatus according to any one of claims 47 to 51, wherein the apparatus is a first user equipment (114) and wherein the filled message is sent to a first network entity (110), such that the first network entity can rebuild the secondary information based on the portions of secondary information and send the secondary information to a second network entity.

57. An apparatus according to claim 56, wherein the second network entity is a web server.

58. An apparatus according to any one of claims 56 and 57, further comprising means for determining whether an amount of messages sent from the first user equipment (114) to the network entity by unit of time is greater than a threshold (906).

59. A non-transitory computer readable medium for equipping an apparatus comprising code, which when executed by a processor, causes the processor to perform a method according to any one of the claims 35 to 46.

60. A method for receiving information over a network, comprising:
receiving a message, comprising a first section filled with primary information and a second section at least partially filled with a portion of secondary information;
separating the message into the primary information and the portion of secondary information (822, 922);
delivering the primary information for use (824, 924); and
storing the portion of secondary information for later rebuilding the secondary information (826, 926).

61. A method according to claim 60, further comprising:
receiving a plurality of messages, comprising a first section filled with primary information and a second section at least partially filled with a portion of secondary information;
separating each message of the plurality of messages into primary information and the portion secondary information (822, 922);
delivering the primary information for use; and
rebuilding the secondary information based on the portions of secondary information (826, 926).

62. A method according to 61, wherein each portion of secondary information has a predetermined size and portions of the secondary information are inserted into only messages for which the size of the secondary information exceeds the predetermined size.

63. A method according to any one of claims 61 to 62, wherein each portion of secondary information has a variable size and wherein the message comprises header information indicating which section is filled with primary information and which section is at least partially filled with secondary information.

64. A method according to any one of claims 61 to 63, wherein the message is received via Short Message Service, SMS.

65. A method according to any one of claims 61 to 64, wherein the method is performed by a user equipment (116), wherein the message is received from a network entity (110).

66. A method according to claim 65, further comprising displaying the primary information of the message (824).

67. A method according to any one of claims 65 and 66, wherein the secondary information comprises; (i) an Advert Delivery Message, ADM, including an index and content and (ii) a User Data Header, UDH, including an indicator indicating that the ADM is to be parsed and stored in an indexed table in the second user equipment, wherein the ADM further comprises at least one of a Global Advertisement Key, a style code, a short code for action and future use.

68. A method according to any one of claims 61 to 64, wherein the method is performed by a network entity (110), wherein the message is received from a first user equipment (114).

69. A method according to claim 68, further comprising sending the secondary information to a second network entity (924).

70. A method according to claim 69, wherein the second network entity is a web server (928).

71. An apparatus for receiving information over a network, comprising:
means for receiving a message, comprising a first section filled with primary information and a second section at least partially filled with a portion of secondary information;
means for separating the message into the primary information and the portions of secondary information (822, 922); and
means for delivering the primary information for use;
means for storing the portion of secondary information for later rebuilding the secondary information.

72. An apparatus according to claim 71, further comprising:
means for receiving a plurality of messages, comprising a first portion occupied by primary information and a second portion occupied by secondary information;
means for separating each message of the plurality of messages into the primary information and the portions of secondary information (822, 922); and
means for rebuilding secondary information based on the portions of secondary information (826, 926).

73. An apparatus according to claim 72, wherein each portion of secondary information has a predetermined size and portions of the secondary information are inserted into only messages for which the size of the secondary information exceeds the predetermined size.

74. An apparatus according to any one of claims 71 to 72, wherein each portion of secondary information has a variable size and wherein the message comprises header information indicating which section is filled with primary information and which section is at least partially filled with secondary information.

75. An apparatus according to any one of claims 71 to 74, wherein the message is received via Short Message Service, SMS.

76. An apparatus according to any one of claims 71 to 75, wherein the method is performed by a user equipment (116), wherein the message is received from a network entity (110).

77. An apparatus according to claim 76, further comprises means for displaying the primary information of the message (824).

78. An apparatus according to any one of claims 76 to 77, wherein the secondary information comprises; (i) an Advert Delivery Message, ADM, including an index and content and (ii) a User Data Header, UDH, including an indicator indicating that the ADM is to be parsed and stored in an indexed table in the second user equipment, wherein the ADM further comprises at least one of a Global Advertisement Key, a style code, a short code for action and future use.

79. An apparatus according to any one of claims 71 to 75, wherein the method is performed by a network entity (110), wherein the message is received from a first user equipment (114).

80. An apparatus according to claim 79, further comprising means for sending the secondary information to a second network entity (924).

81. An apparatus according to claim 80, wherein the second network entity is a web server.

82. A non-transitory computer readable medium for equipping an apparatus comprising code, which when executed by a processor, causes the processor to perform a method according to any one of the claims 60 to 70.
